(19) United States
(12) Patent Application Publication
(10) Pub. No.: US 2022/0244447 A1
(43) Pub. Date: Aug. 4, 2022

(54) MULTIVIEW BACKLIGHT, MULTIVIEW DISPLAY, AND METHOD HAVING MICRO-SLIT MULTIBEAM ELEMENTS

(71) Applicant: LEIA INC., Menlo Park, CA (US)

(72) Inventors: David A. Fattal, Menlo Park, CA (US); Thomas Hoekman, Menlo Park, CA (US); Colton Bukowsky, Menlo Park, CA (US); Ming Ma, Menlo Park, CA (US)

(21) Appl. No.: 17/724,431

(22) Filed: Apr. 19, 2022

Related U.S. Application Data
(63) Continuation of application No. PCT/US2020/056533, filed on Oct. 20, 2020.
(60) Provisional application No. 62/924,650, filed on Oct. 22, 2019.

(51) Int. Cl. F21V 8/00; G02B 30/30; G02B 30/33

(52) U.S. Cl. CPC G02B 6/0036; G02B 6/0051; G02B 30/33; G02B 6/0055; G02B 30/30

(57) ABSTRACT

A multiview backlight, multiview display, and method of multiview backlight operation include micro-slit multibeam elements configured to provide emitted light having directional light beams with directions corresponding to view directions of a multiview image. The multiview backlight includes a light guide configured to guide light and an array of the micro-slit multibeam elements, each micro-slit multibeam element including a plurality of micro-slit sub-elements and being configured to reflectively scatter out a portion of the guided light as the emitted light. Each micro-slit sub-element of the micro-slit sub-element plurality includes a sloped reflective sidewall having a slope angle tilted away from the propagation direction of the guided light. The multiview display includes the multiview backlight and an array of light valves to modulate the directional light beams to provide the multiview image.

### CROSS-REFERENCE TO RELATED APPLICATION

This application is a continuation patent application of and claims priority to International Patent Application No. PCT/US2020/056533, filed Oct. 20, 2020, which claims the benefit of priority to U.S. Provisional Patent Application Ser. No. 62/924,650, filed Oct. 22, 2019, the entire contents of both of which are incorporated by reference herein.

### STATEMENT REGARDING FEDERALLY SPONSORED RESEARCH OR DEVELOPMENT

N/A

### BACKGROUND

Electronic displays are a nearly ubiquitous medium for communicating information to users of a wide variety of devices and products. Most commonly employed electronic displays include the cathode ray tube (CRT), plasma display panels (PDP), liquid crystal displays (LCD), electroluminescent displays (EL), organic light emitting diode (OLED) and active matrix OLEDs (AMOLED) displays, electrophoretic displays (EP) and various displays that employ electromechanical or electrofluidic light modulation (e.g., digital micromirror devices, electrowetting displays, etc.). Generally, electronic displays may be categorized as either active displays (i.e., displays that emit light) or passive displays (i.e., displays that modulate light provided by another source). Examples of active displays include CRTs, PDPs and OLEDs/AMOLEDs. Example of passive displays include LCDs and EP displays. Passive displays, while often exhibiting attractive performance characteristics including, but not limited to, inherently low power consumption, may find somewhat limited use in many practical applications given the lack of an ability to emit light.

### BRIEF DESCRIPTION OF THE DRAWINGS

Various features of examples and embodiments in accordance with the principles described herein may be more readily understood with reference to the following detailed description taken in conjunction with the accompanying drawings, where like reference numerals designate like structural elements.

FIG. 1 illustrates a perspective view of a multiview display in an example according to an embodiment consistent with the principles described herein.

FIG. 2 illustrates a graphical representation of the angular components of a light beam having a particular principal angular direction corresponding to a view direction of a multiview display in an example, according to an embodiment consistent with the principles described herein.

FIG. 3A illustrates a cross sectional view of a multiview backlight in an example, according to an embodiment consistent with the principles described herein.

FIG. 3B illustrates a plan view of a multiview backlight in an example, according to an embodiment consistent with the principles described herein.

FIG. 3C illustrates a perspective view of a multiview backlight in an example, according to an embodiment consistent with the principles described herein.

FIG. 4A illustrates a plan view of a multiview backlight in an example, according to an embodiment consistent with the principles described herein.

FIG. 4B illustrates a plan view of a multiview backlight in an example, according to another embodiment consistent with the principles described herein.

FIG. 5A illustrates a cross-sectional view of a portion of a multiview backlight in an example, according to an embodiment of the principles described herein.

FIG. 5B illustrates a cross-sectional view of a portion of a multiview backlight in an example, according to another embodiment of the principles described herein.

FIG. 5C illustrates a cross-sectional view of a portion of a multiview backlight in an example, according to another embodiment of the principles described herein.

FIG. 6 illustrates a cross-sectional view of a portion of a multiview backlight including a micro-slit sub-element in an example, according to an embodiment consistent with the principles described herein.

FIG. 7 illustrates a perspective view of a curved micro-slit sub-element in an example, according to an embodiment consistent with the principles described herein.

FIG. 8 illustrates a block diagram of a multiview display in an example, according to an embodiment consistent with the principles described herein.

FIG. 9 illustrates a flow chart of a method of multiview backlight operation in an example, according to an embodiment consistent with the principles described herein.

Certain examples and embodiments have other features that are one of in addition to and in lieu of the features illustrated in the above-referenced figures. These and other features are detailed below with reference to the above-referenced figures.

### DETAILED DESCRIPTION

Examples and embodiments in accordance with the principles described herein provide multiview backlighting having applications to a multiview display. In particular, embodiments consistent with the principles described herein provide a multiview backlight that employs an array of micro-slit multibeam elements configured to provide emitted light. The emitted light comprises directional light beams having directions corresponding to respective view directions of a multiview display. According to various embodiments, micro-slit multibeam elements of the micro-slit multibeam element array comprise a plurality of micro-slit sub-elements configured to reflectively scatter light out from a light guide as the emitted light. The presence of the plurality of micro-slit sub-elements within the micro-slit multibeam elements may facilitate granular control of reflective scattering properties of the emitted light. For example, the micro-slit sub-elements may provide granular control of scattering direction, magnitude, and Moiré mitigation associated with the various micro-slit multibeam elements. Uses of multiview displays that employ the multiview backlight described herein include, but are not limited to, mobile telephones (e.g., smart phones), watches, tablet computes, mobile computers (e.g., laptop computers), personal computers and computer monitors, automobile display consoles, cameras displays, and various other mobile as well as substantially non-mobile display applications and devices.

Herein a ‘two-dimensional display’ or ‘2D display’ is defined as a display configured to provide a view of an image that is substantially the same regardless of a direction from which the image is viewed (i.e., within a predefined viewing angle or range of the 2D display). A conventional liquid crystal display (LCD) found in many smart phones and computer monitors are examples of 2D displays. In contrast herein, a ‘multiview display’ is defined as an electronic display or display system configured to provide different views of a multiview image in or from different view directions. In particular, the different views may represent different perspective views of a scene or object of the multiview image, according to some embodiments.

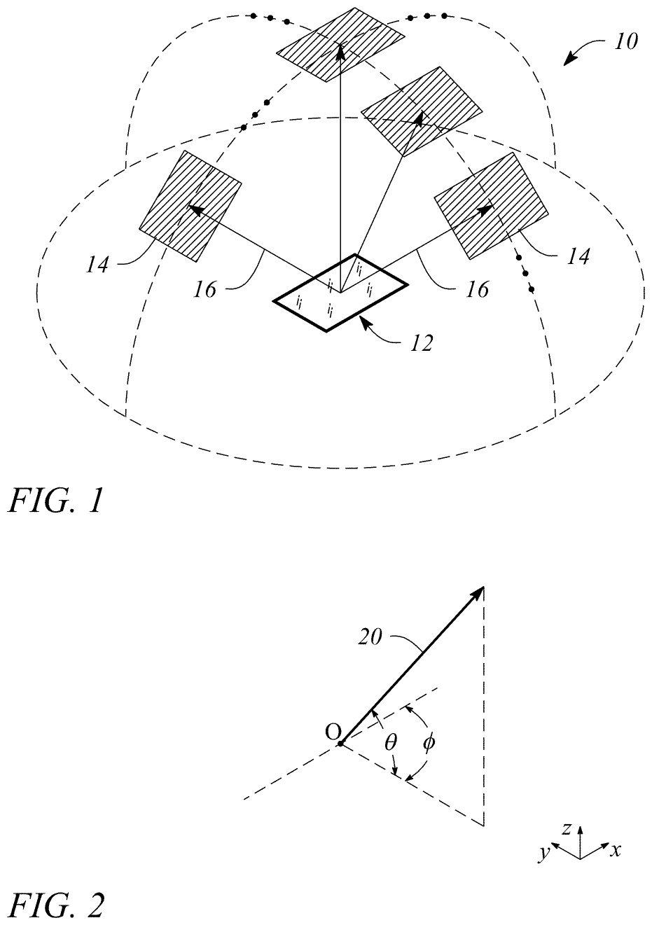

FIG. 1 illustrates a perspective view of a multiview display 10 in an example, according to an embodiment consistent with the principles described herein. As illustrated in FIG. 1, the multiview display 10 comprises a screen 12 to display a multiview image to be viewed. The screen 12 may be a display screen of a telephone (e.g., mobile telephone, smart phone, etc.), a tablet computer, a laptop computer, a computer monitor of a desktop computer, a camera display, or an electronic display of substantially any other device, for example. The multiview display 10 provides different views 14 of the multiview image in different view directions 16 relative to the screen 12. The view directions 16 are illustrated as arrows extending from the screen 12 in various different principal angular directions; the different views 14 are illustrated as shaded polygonal boxes at the termination of the arrows (i.e., depicting the view directions 16); and only four views 14 and four view directions 16 are illustrated, all by way of example and not limitation. Note that while the different views 14 are illustrated in FIG. 1 as being above the screen, the views 14 actually appear on or in a vicinity of the screen 12 when the multiview image is displayed on the multiview display 10. Depicting the views 14 above the screen 12 is only for simplicity of illustration and is meant to represent viewing the multiview display 10 from a respective one of the view directions 16 corresponding to a particular view 14. A 2D display may be substantially similar to the multiview display 10, except that the 2D display is generally configured to provide a single view (e.g., one view similar to view 14) of a displayed image as opposed to the different views 14 of the multiview image provided by the multiview display 10.

A view direction or equivalently a light beam having a direction corresponding to a view direction of a multiview display generally has a principal angular direction or simply a ‘direction’ given by angular components {θ, ϕ}, by definition herein. The angular component Bis referred to herein as the ‘elevation component’ or ‘elevation angle’ of the light beam. The angular component ϕ is referred to as the ‘azimuth component’ or ‘azimuth angle’ of the light beam. By definition, the elevation angle θ is an angle in a vertical plane (e.g., perpendicular to a plane of the multiview display screen while the azimuth angle ϕ is an angle in a horizontal plane (e.g., parallel to the multiview display screen plane).

FIG. 2 illustrates a graphical representation of the angular components {θ, ϕ} of a light beam 20 having a particular principal angular direction corresponding to a view direction (e.g., view direction 16 in FIG. 1) of a multiview display in an example, according to an embodiment consistent with the principles described herein. In addition, the light beam 20 is emitted or emanates from a particular point, by definition herein. That is, by definition, the light beam 20 has a central ray associated with a particular point of origin within the multiview display. FIG. 2 also illustrates the light beam (or view direction) point of origin O.

Herein, the term ‘multiview’ as used in the terms ‘multiview image’ and ‘multiview display’ is defined as a plurality of views representing different perspectives or including angular disparity between views of the view plurality. In addition, herein the term ‘multiview’ may explicitly include more than two different views (i.e., a minimum of three views and generally more than three views). As such, ‘multiview display’ as employed herein may be explicitly distinguished from a stereoscopic display that includes only two different views to represent a scene or an image. Note however, while multiview images and multiview displays include more than two views, by definition herein, multiview images may be viewed (e.g., on a multiview display) as a stereoscopic pair of images by selecting only two of the multiview views to view at a time (e.g., one view per eye).

A ‘multiview pixel’ is defined herein as a set of pixels representing ‘view’ pixels in each of a similar plurality of different views of a multiview display. In particular, a multiview pixel may have an individual pixel or set of pixels corresponding to or representing a view pixel in each of the different views of the multiview image. By definition herein therefore, a ‘view pixel’ is a pixel or set of pixels corresponding to a view in a multiview pixel of a multiview display. In some embodiments, a view pixel may include one or more color sub-pixels. Moreover, the view pixels of the multiview pixel are so-called ‘directional pixels’ in that each of the view pixels is associated with a predetermined view direction of a corresponding one of the different views, by definition herein. Further, according to various examples and embodiments, the different view pixels a multiview pixel may have equivalent or at least substantially similar locations or coordinates in each of the different views. For example, a first multiview pixel may have individual view pixels located at {x1, y1} in each of the different views of a multiview image, while a second multiview pixel may have individual view pixels located at {x2, y2} in each of the different views, and so on.

Herein, a ‘light guide’ is defined as a structure that guides light within the structure using total internal reflection. In particular, the light guide may include a core that is substantially transparent at an operational wavelength of the light guide. The term ‘light guide’ generally refers to a dielectric optical waveguide that employs total internal reflection to guide light at an interface between a dielectric material of the light guide and a material or medium that surrounds that light guide. By definition, a condition for total internal reflection is that a refractive index of the light guide is greater than a refractive index of a surrounding medium adjacent to a surface of the light guide material. In some embodiments, the light guide may include a coating in addition to or instead of the aforementioned refractive index difference to further facilitate the total internal reflection. The coating may be a reflective coating, for example. The light guide may be any of several light guides including, but not limited to, one or both of a plate or slab guide and a strip guide.

Further herein, the term ‘plate’ when applied to a light guide as in a ‘plate light guide’ is defined as a piece-wise or differentially planar layer or sheet, which is sometimes referred to as a ‘slab’ guide. In particular, a plate light guide is defined as a light guide configured to guide light in two substantially orthogonal directions bounded by a top surface and a bottom surface (i.e., opposite surfaces) of the light guide. Further, by definition herein, the top and bottom surfaces are both separated from one another and may be substantially parallel to one another in at least a differential sense. That is, within any differentially small section of the plate light guide, the top and bottom surfaces are substantially parallel or co-planar. In some embodiments, the plate light guide may be substantially flat (i.e., confined to a plane) and therefore, the plate light guide is a planar light guide. In other embodiments, the plate light guide may be curved in one or two orthogonal dimensions. For example, the plate light guide may be curved in a single dimension to form a cylindrical shaped plate light guide. However, any curvature has a radius of curvature sufficiently large to ensure that total internal reflection is maintained within the plate light guide to guide light.

By definition herein, a ‘multibeam element’ is a structure or element of a backlight or a display that produces emitted light that includes a plurality of directional light beams. In some embodiments, the multibeam element may be optically coupled to a light guide of a backlight to provide the plurality of light beams by coupling or scattering out a portion of light guided in the light guide. In other embodiments, the multibeam element may generate light emitted as the directional light beams (e.g., may comprise a light source). Further, the directional light beams of the plurality of directional light beams produced by a multibeam element have different principal angular directions from one another, by definition herein. In particular, by definition, a directional light beam of the plurality has a predetermined principal angular direction that is different from another directional light beam of the directional light beam plurality. Furthermore, the directional light beam plurality may represent a light field. For example, the directional light beam plurality may be confined to a substantially conical region of space or have a predetermined angular spread that includes the different principal angular directions of the directional light beams in the light beam plurality. As such, the predetermined angular spread of the directional light beams in combination (i.e., the light beam plurality) may represent the light field.

According to various embodiments, the different principal angular directions of the various directional light beams of the plurality are determined by a characteristic including, but not limited to, a size (e.g., length, width, area, etc.) and an orientation or rotation of the multibeam element. In some embodiments, the multibeam element may be considered an ‘extended point light source’, i.e., a plurality of point light sources distributed across an extent of the multibeam element, by definition herein. Further, a directional light beam produced by the multibeam element has a principal angular direction given by angular components {θ, ϕ}, by definition herein, and as described above with respect to FIG. 2.

Herein, an ‘angle-preserving scattering feature’ or equivalently an ‘angle-preserving scatterer’ is defined as any feature or scatterer configured to scatter light in a manner that substantially preserves in scattered light an angular spread of light incident on the feature or scatterer. In particular, by definition, an angular spread σₛ of light scattered by an angle-preserving scattering feature is a function of an angular spread σ of the incident light (i.e., σₛ=f(σ)). In some embodiments, the angular spread σₛ of the scattered light is a linear function of the angular spread or collimation factor σ of the incident light (e.g., σₛ=a·σ, where a is an integer). That is, the angular spread σₛ of light scattered by an angle-preserving scattering feature may be substantially proportional to the angular spread or collimation factor σ of the incident light. For example, the angular spread σₛ of the scattered light may be substantially equal to the incident light angular spread σ (e.g., σₛ≅σ). A uniform diffraction grating (i.e., a diffraction grating having a substantially uniform or constant diffractive feature spacing or grating pitch) is an example of an angle-preserving scattering feature. In contrast, a Lambertian scatterer or reflector as well as a general diffuser (e.g., having or approximating Lambertian scattering) are not angle-preserving scatterers, by definition herein.

Herein a ‘collimator’ is defined as substantially any optical device or apparatus that is configured to collimate light. According to various embodiments, an amount of collimation provided by the collimator may vary in a predetermined degree or amount from one embodiment to another. Further, the collimator may be configured to provide collimation in one or both of two orthogonal directions (e.g., a vertical direction and a horizontal direction). That is, the collimator may include a shape in one or both of two orthogonal directions that provides light collimation, according to some embodiments.

Herein, a ‘collimation factor’ is defined as a degree to which light is collimated. In particular, a collimation factor defines an angular spread of light rays within a collimated beam of light, by definition herein. For example, a collimation factor σ may specify that a majority of light rays in a beam of collimated light is within a particular angular spread (e.g., +/−σ degrees about a central or principal angular direction of the collimated light beam). The light rays of the collimated light beam may have a Gaussian distribution in terms of angle and the angular spread may be an angle determined by at one-half of a peak intensity of the collimated light beam, according to some examples.

Herein, a ‘light source’ is defined as a source of light (e.g., an optical emitter configured to produce and emit light). For example, the light source may comprise an optical emitter such as a light emitting diode (LED) that emits light when activated or turned on. In particular, herein the light source may be substantially any source of light or comprise substantially any optical emitter including, but not limited to, one or more of a light emitting diode (LED), a laser, an organic light emitting diode (OLED), a polymer light emitting diode, a plasma-based optical emitter, a fluorescent lamp, an incandescent lamp, and virtually any other source of light. The light produced by the light source may have a color (i.e., may include a particular wavelength of light), or may be a range of wavelengths (e.g., white light). In some embodiments, the light source may comprise a plurality of optical emitters. For example, the light source may include a set or group of optical emitters in which at least one of the optical emitters produces light having a color, or equivalently a wavelength, that differs from a color or wavelength of light produced by at least one other optical emitter of the set or group. The different colors may include primary colors (e.g., red, green, blue) for example.

As used herein, the article ‘a’ is intended to have its ordinary meaning in the patent arts, namely ‘one or more’. For example, ‘a micro-slit multibeam element’ means one or more micro-slit multibeam element and as such, ‘the micro-slit multibeam element’ means ‘micro-slit multibeam element(s)’ herein. Also, any reference herein to ‘top’, ‘bottom’, ‘upper’, ‘lower’, ‘up’, ‘down’, ‘front’, back’, ‘first’, ‘second’, ‘left’ or ‘right’ is not intended to be a limitation herein. Herein, the term ‘about’ when applied to a value generally means within the tolerance range of the equipment used to produce the value, or may mean plus or minus 10%, or plus or minus 5%, or plus or minus 1%, unless otherwise expressly specified. Further, the term ‘substantially’ as used herein means a majority, or almost all, or all, or an amount within a range of about 51% to about 100%. Moreover, examples herein are intended to be illustrative only and are presented for discussion purposes and not by way of limitation.

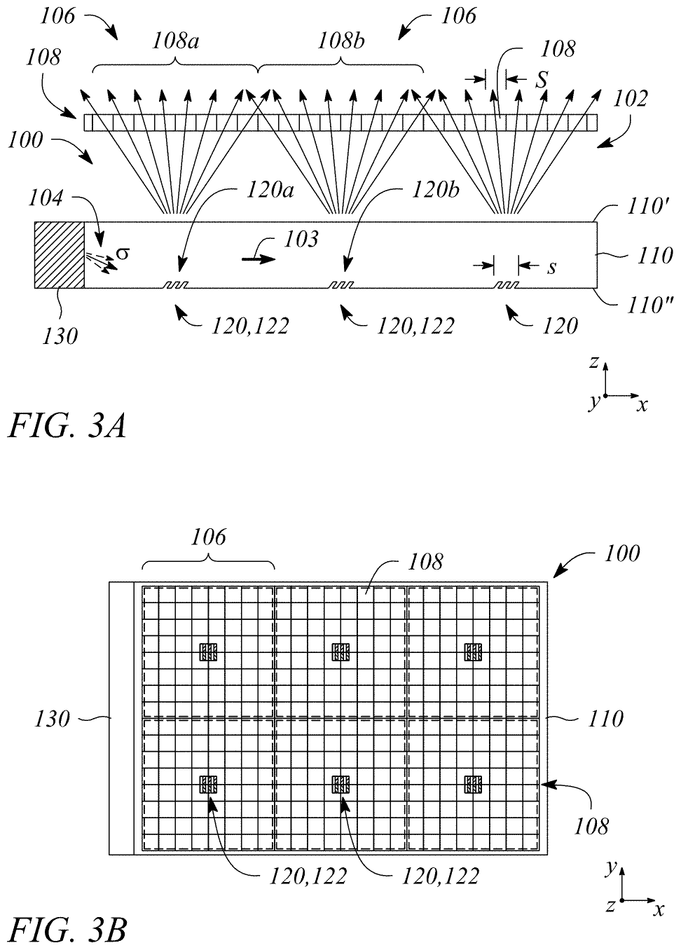

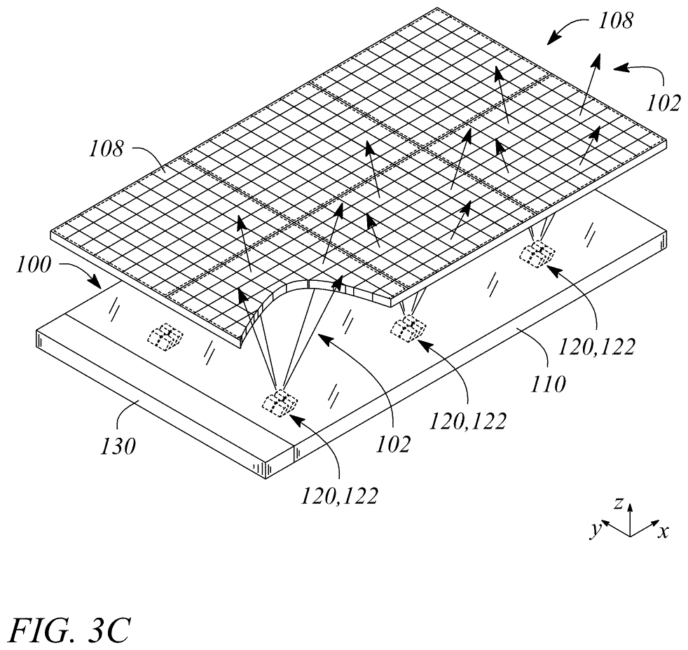

According to some embodiments of the principles described herein, a multiview backlight is provided. FIG. 3A illustrates a cross sectional view of a multiview backlight 100 in an example, according to an embodiment consistent with the principles described herein. FIG. 3B illustrates a plan view of a multiview backlight 100 in an example, according to an embodiment consistent with the principles described herein. FIG. 3C illustrates a perspective view of a multiview backlight 100 in an example, according to an embodiment consistent with the principles described herein. The perspective view in FIG. 3C is depicted with a partial cut-away to facilitate discussion herein only.

The multiview backlight 100 illustrated in FIGS. 3A-3C is configured to provide emitted light 102 comprising directional light beams having different principal angular directions from one another (e.g., as or representing a light field). In particular, the directional light beams of the emitted light 102 are reflectively scattered out of the multiview backlight 100 and directed away from the multiview backlight 100 in different directions corresponding to respective view directions of a multiview display or equivalently different view directions of a multiview image displayed by the multiview display. In some embodiments, the directional light beams of the emitted light 102 may be modulated (e.g., using light valves, as described below) to facilitate the display of information having multiview content, e.g., a multiview image. The multiview image may represent or include three-dimensional (3D) content, for example. FIGS. 3A-3C also illustrate a multiview pixel 106 comprising an array of light valves 108. A surface of the multiview backlight 100 through which the directional light beams of the emitted light 102 are reflectively scattered out of and toward the light valves 108 may be referred to as an ‘emission surface’ of the multiview backlight 100.

As illustrated in FIGS. 3A-3C, the multiview backlight 100 comprises a light guide 110. The light guide 110 is configured to guide light in a propagation direction 103 as guided light 104. Further, the guided light 104 may have or be guided according to a predetermined collimation factor σ, in various embodiments. For example, the light guide 110 may include a dielectric material configured as an optical waveguide. The dielectric material may have a first refractive index that is greater than a second refractive index of a medium surrounding the dielectric optical waveguide. The difference in refractive indices may be configured to facilitate total internal reflection of the guided light 104 according to one or more guided modes of the light guide 110.

In some embodiments, the light guide 110 may be a slab or plate optical waveguide (i.e., a plate light guide) comprising an extended, substantially planar sheet of optically transparent, dielectric material. The substantially planar sheet of dielectric material is configured to guide the guided light 104 using total internal reflection. According to various examples, the optically transparent material of the light guide 110 may include or be made up of any of a variety of dielectric materials including, but not limited to, one or more of various types of glass (e.g., silica glass, alkali-aluminosilicate glass, borosilicate glass, etc.) and substantially optically transparent plastics or polymers (e.g., poly(methyl methacrylate) or ‘acrylic glass’, polycarbonate, and others). In some embodiments, the light guide 110 may further include a cladding layer (not illustrated) on at least a portion of a surface (e.g., one or both of the top surface and the bottom surface) of the light guide 110. The cladding layer may be used to further facilitate total internal reflection, according to some examples. In particular, the cladding may comprise a material having an index of refraction that is greater than an index of refraction of the light guide material.

Further, according to some embodiments, the light guide 110 is configured to guide the guided light 104 according to total internal reflection at a non-zero propagation angle between a first surface 110′ (e.g., ‘front’ or ‘top’ surface or side) and a second surface 110″ (e.g., ‘back’ or ‘bottom’ surface or side) of the light guide 110. In particular, the guided light 104 propagates as a guided light beam by reflecting or ‘bouncing’ between the first surface 110′ and the second surface 110″ of the light guide 110 at the non-zero propagation angle. In some embodiments, the guided light 104 may include a plurality of guided light beams representing different colors of light. The different colors of light may be guided by the light guide 110 at respective ones of different color-specific, nonzero propagation angles. Note, the non-zero propagation angle is not illustrated in FIGS. 3A-3C for simplicity of illustration. However, a bold arrow representing the propagation direction 103 depicts a general propagation direction of the guided light 104 along the light guide length in FIG. 3A.

As defined herein, a ‘non-zero propagation angle’ is an angle relative to a surface (e.g., the first surface 110′ or the second surface 110″) of the light guide 110. Further, the non-zero propagation angle is both greater than zero and less than a critical angle of total internal reflection within the light guide 110, according to various embodiments. For example, the non-zero propagation angle of the guided light 104 may be between about ten degrees (10°) and about fifty degrees (50°) or, between about twenty degrees (20°) and about forty degrees (40°), or between about twenty-five degrees (25°) and about thirty-five (35°) degrees. For example, the non-zero propagation angle may be about thirty (30°) degrees. In other examples, the non-zero propagation angle may be about 20°, or about 25°, or about 35°. Moreover, a specific non-zero propagation angle may be chosen (e.g., arbitrarily) for a particular implementation as long as the specific non-zero propagation angle is chosen to be less than the critical angle of total internal reflection within the light guide 110.

The guided light 104 in the light guide 110 may be introduced or directed into the light guide 110 at the non-zero propagation angle (e.g., about 30-35 degrees). In some embodiments, a structure such as, but not limited to, a lens, a mirror or similar reflector (e.g., a tilted collimating reflector), a diffraction grating, and a prism (not illustrated) as well as various combinations thereof may be employed to introduce light into the light guide 110 as the guided light 104. In other examples, light may be introduced directly into the input end of the light guide 110 either without or substantially without the use of a structure (i.e., direct or ‘butt’ coupling may be employed). Once directed into the light guide 110, the guided light 104 is configured to propagate along the light guide 110 in the propagation direction 103 that is generally away from the input end.

Further, the guided light 104, having the predetermined collimation factor σ may be referred to as a ‘collimated light beam’ or ‘collimated guided light.’ Herein, a ‘collimated light’ or a ‘collimated light beam’ is generally defined as a beam of light in which rays of the light beam are substantially parallel to one another within the light beam (e.g., the guided light beam), except as allowed by the collimation factor σ. Further, rays of light that diverge or are scattered from the collimated light beam are not considered to be part of the collimated light beam, by definition herein.

As illustrated in FIGS. 3A-3C, the multiview backlight 100 further comprises an array of micro-slit multibeam elements 120 spaced apart from one another across the light guide 110. In particular, the micro-slit multibeam elements 120 of the array are separated from one another by a finite space and represent individual, distinct elements across the light guide 110. That is, by definition herein, the micro-slit multibeam elements 120 of the array are spaced apart from one another according to a finite (i.e., non-zero) inter-element distance (e.g., a finite center-to-center distance). Further, the micro-slit multibeam elements 120 of the array generally do not intersect, overlap or otherwise touch one another, according to some embodiments. As such, each micro-slit multibeam element 120 of the array is generally distinct and separated from other ones of the micro-slit multibeam elements 120. In some embodiments, the micro-slit multibeam elements 120 may be spaced apart by a distance that is greater than a size of individual ones of the micro-slit multibeam elements 120.

According to some embodiments, the micro-slit multibeam elements 120 of the array may be arranged in either a one-dimensional (1D) array or a two-dimensional (2D) array. For example, the micro-slit multibeam elements 120 may be arranged as a linear 1D array (e.g., a plurality of lines comprising staggered lines of micro-slit multibeam elements 120). In another example, the micro-slit multibeam elements 120 may be arranged as a rectangular 2D array or as a circular 2D array. Further, the array (i.e., 1D or 2D array) may be a regular or uniform array, in some embodiments. In particular, an inter-element distance (e.g., center-to-center distance or spacing) between the micro-slit multibeam elements 120 may be substantially uniform or constant across the array. In other examples, the inter-element distance between the micro-slit multibeam elements 120 may be varied one or both of across the array, along the length of the light guide 110, or across the light guide 110.

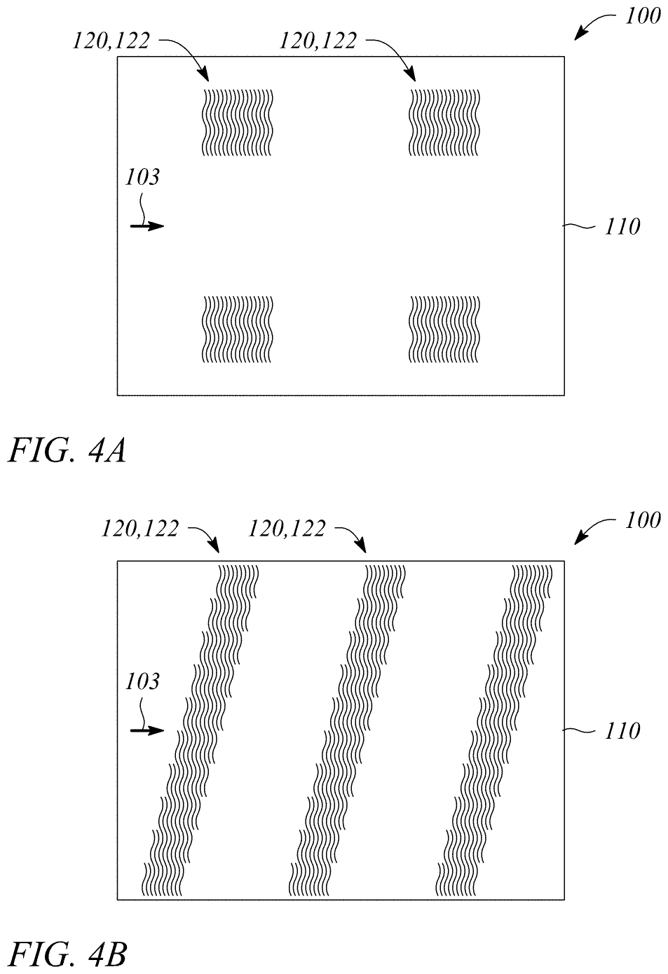

FIG. 4A illustrates a plan view of a multiview backlight 100 in an example, according to an embodiment consistent with the principles described herein. In particular, FIG. 4A illustrates the multiview backlight 100 with micro-slit multibeam elements 120 arranged in a 2D array across the light guide 110. The guided light propagation direction 103 is also illustrated in FIG. 4A. As illustrated the 2D array of micro-slit multibeam elements 120 represents a rectangular array. The micro-slit multibeam elements 120 arranged in a 2D array may be used in conjunction with a full-parallax multiview display having a 2D arrangement of views such as a rectangular view arrangement (e.g., 2×4 views, 2×8 views, 4×8 views, etc.) or a square view arrangement (e.g., 2×2 views, or 4×4 views, etc.), for example.

FIG. 4B illustrates a plan view of a multiview backlight 100 in an example, according to another embodiment consistent with the principles described herein. As illustrated in FIG. 4B, the multiview backlight 100 comprises micro-slit multibeam elements 120 arranged in a 1D array across the light guide 110. In particular, the micro-slit multibeam elements 120 are arranged in the 1D array as slanted linear or slanted line scattering elements, as illustrated. The micro-slit multibeam elements 120 arranged in a 1D array (e.g., as slanted line scattering elements) may be used in conjunction with a horizontal-parallax-only (HPO) multiview display having a 1D arrangement of views (e.g., 1×4 views, 1×8 views, etc.). FIG. 4B also illustrates the guided light propagation direction 103 oriented across the 1D array. The guided light propagation direction 103 may also correspond to the 1D arrangement of views, according to some embodiments.

According to various embodiments, each micro-slit multibeam element 120 of the micro-slit multibeam element array comprises a plurality of micro-slit sub-elements 122. Furthermore, each micro-slit multibeam element 120 of the micro-slit multibeam element array is configured to reflectively scatter out a portion of the guided light 104 as emitted light 102 comprising the directional light beams. In particular, the guided light portion is reflectively scattered out collectively by micro-slit sub-elements of the micro-slit multibeam element 120 using reflection or reflective scattering, according to various embodiments. According to various embodiments, each micro-slit sub-element 122 of the micro-slit sub-element plurality comprises a sloped reflective sidewall having a slope angle tilted away from the propagation direction of the guided light, by definition herein. Reflective scattering is configured to occur at or is provided by the sloped reflective sidewall of the micro-slit sub-element 122, according to various embodiments. FIGS. 3A and 3C illustrate the directional light beams of the emitted light 102 as a plurality of diverging arrows directed way from the first surface 110′ (i.e., emission surface) of the light guide 110.

According to various embodiments, a size of each of the micro-slit multibeam elements 120 that includes within the size the micro-slit sub-element plurality (e.g., as illustrated a lower-case ‘s’ in FIG. 3A) is comparable to a size of a light valve 108 (e.g., as illustrated by an upper-case ‘S’ in FIG. 3A) in a multiview display. Herein, the ‘size’ may be defined in any of a variety of manners to include, but not be limited to, a length, a width or an area. For example, the size of a light valve 108 may be a length thereof and the comparable size of the micro-slit multibeam element 120 may also be a length of the micro-slit multibeam element 120. In another example, the size may refer to an area such that an area of the micro-slit multibeam element 120 may be comparable to an area of the light valve 108.

In some embodiments, a size of each micro-slit multibeam element 120 is between about twenty-five percent (25%) and about two hundred percent (200%) of a size of a light valve 108 in light valve array of the multiview display. In other examples, the micro-slit multibeam element size is greater than about fifty percent (50%) of the light valve size, or greater than about sixty percent (60%) of the light valve size, or greater than about seventy percent (70%) of the light valve size, or greater than about seventy-five percent (75%) of the light valve size, or greater than about eighty percent (80%) of the light valve size, or greater than about eighty-five percent (85%) of the light valve size, or greater than about ninety percent (90%) of the light valve size. In other examples, the micro-slit multibeam element size is less than about one hundred eighty percent (180%) of the light valve size, or less than about one hundred sixty percent (160%) of the light valve size, or less than about one hundred forty percent (140%) of the light valve size, or less than about one hundred twenty percent (120%) of the light valve size.

According to some embodiments, the comparable sizes of the micro-slit multibeam element 120 and the light valve 108 may be chosen to reduce, or in some embodiments to minimize, dark zones between views of the multiview display. Moreover, the comparable sizes of the micro-slit multibeam element 120 and the light valve 108 may be chosen to reduce, and in some embodiments to minimize, an overlap between views (or view pixels) of the multiview display. FIGS. 3A-3C illustrate an array of light valves 108 configured to modulate the directional light beams of the emitted light 102. The light valve array may be part of a multiview display that employs the multiview backlight 100, for example. The array of light valves 108 is illustrated in FIGS. 3A-3C along with the multiview backlight 100 for the purpose of facilitating discussion.

As illustrated in FIGS. 3A-3C, different ones of the directional light beams of the emitted light 102 having different principal angular directions pass through and may be modulated by different ones of the light valves 108 in the light valve array. Further, as illustrated, a light valve 108 of the array corresponds to a sub-pixel of the multiview pixel 106, and a set of the light valves 108 may correspond to a multiview pixel 106 of the multiview display. In particular, in some embodiments, a different set of light valves 108 of the light valve array is configured to receive and modulate the directional light beams of the emitted light 102 provided by or from a corresponding one of the micro-slit multibeam elements 120, i.e., there is one unique set of light valves 108 for each micro-slit multibeam element 120, as illustrated. In various embodiments, different types of light valves may be employed as the light valves 108 of the light valve array including, but not limited to, one or more of liquid crystal light valves, electrophoretic light valves, and light valves based on electrowetting.

Note that, as illustrated in FIG. 3A, the size of a sub-pixel of a multiview pixel 106 may correspond to a size of a light valve 108 in the light valve array. In other examples, the light valve size may be defined as a distance (e.g., a center-to-center distance) between adjacent light valves 108 of the light valve array. For example, the light valves 108 may be smaller than the center-to-center distance between the light valves 108 in the light valve array. The light valve size may be defined as either the size of the light valve 108 or a size corresponding to the center-to-center distance between the light valves 108, for example.

In some embodiments, a relationship between the micro-slit multibeam elements 120 and corresponding multiview pixels 106 (i.e., sets of sub-pixels and corresponding sets of light valves 108) may be a one-to-one relationship. That is, there may be an equal number of multiview pixels 106 and micro-slit multibeam elements 120. FIG. 3B explicitly illustrates by way of example the one-to-one relationship where each multiview pixel 106 comprising a different set of light valves 108 is illustrated as surrounded by a dashed line. In other embodiments (not illustrated), the number of multiview pixels 106 and the number of micro-slit multibeam elements 120 may differ from one another.

In some embodiments, an inter-element distance (e.g., center-to-center distance) between a pair of micro-slit multibeam elements 120 of the plurality may be equal to an inter-pixel distance (e.g., a center-to-center distance) between a corresponding pair of multiview pixels 106, e.g., represented by light valve sets. For example, as illustrated in FIG. 3A, a center-to-center distance between the first micro-slit multibeam element 120a and the second micro-slit multibeam element 120b is substantially equal to a center-to-center distance between the first light valve set 108a and the second light valve set 108b. In other embodiments (not illustrated), the relative center-to-center distances of pairs of micro-slit multibeam elements 120 and corresponding light valve sets may differ, e.g., the micro-slit multibeam elements 120 may have an inter-element spacing that is one of greater than or less than a spacing between light valve sets representing multiview pixels 106.

Further (e.g., as illustrated in FIG. 3A), each micro-slit multibeam element 120 may be configured to provide directional light beams of the emitted light 102 to one and only one multiview pixel 106, according to some embodiments. In particular, for a given one of the micro-slit multibeam elements 120, the directional light beams having different principal angular directions corresponding to the different views of the multiview display may be substantially confined to a single corresponding multiview pixel 106 and the sub-pixels thereof, i.e., a single set of light valves 108 corresponding to the micro-slit multibeam element 120. As such, each micro-slit multibeam element 120 of the multiview backlight 100 provides a corresponding set of directional light beams of the emitted light 102 that has a set of the different principal angular directions corresponding to the different views of the multiview display (i.e., the set of directional light beams contains a light beam having a direction corresponding to each of the different view directions).

As illustrated in FIG. 3A, a first light valve set 108a is configured to receive and modulate the directional light beams of the emitted light 102 from the first micro-slit multibeam element 120a. Further, the second light valve set 108b is configured to receive and modulate the directional light beams of the emitted light 102 from a second micro-slit multibeam element 120b. As a result, each of the light valve sets (e.g., the first and second light valve sets 108a, 108b) in the light valve array corresponds, respectively, both to a different micro-slit multibeam element 120 (e.g., elements 120a, 120b) and to a different multiview pixel 106, with individual light valves 108 of the light valve sets corresponding to the sub-pixels of the respective multiview pixels 106.

In some embodiments, a micro-slit multibeam element 120 of the micro-slit multibeam element array may be disposed on or at a surface of the light guide 110. For example, the micro-slit multibeam element 120 may be disposed on the second surface 110″ opposite to the emission surface (e.g., first surface 110′) of the light guide 110, e.g., as illustrated in FIG. 3A. In this example, a micro-slit sub-element 122 of the micro-slit sub-element plurality extends into an interior of the light guide 110 and toward the emission surface. In another example, the micro-slit multibeam element 120 may be disposed on or at the emission surface (e.g., the first surface 110′) of the light guide 110 and a micro-slit sub-element 122 of the micro-slit sub-element plurality may extend into an interior of the light guide 110 away from the emission surface.

In other embodiments, the micro-slit multibeam element 120 may be located within the light guide 110. In particular, the micro-slit sub-element plurality of the micro-slit multibeam element 120 may be located between and spaced away from both of the first surface 110′ and the second surface 110″ of the light guide 110, in these embodiments. For example, the micro-slit multibeam element 120 may be provided on a surface of the light guide 110 and then covered by layer of light guide material to effectively bury the micro-slit multibeam element 120 in an interior of the light guide 110.

In yet another embodiment, the micro-slit multibeam element 120 may be disposed in an optical material layer located on a surface of the light guide 110. In some these embodiments, a surface of the optical material layer may be the emission surface and a micro-slit sub-element 122 of the micro-slit sub-element plurality may extend away from the emission surface and toward the light guide surface. The optical material layer located on the surface of the light guide 110 may be index-matched to a refractive index to a material of the light guide 110 to reduce or substantially minimize reflection of light at an interface between the light guide 110 and the material layer, in some embodiments. In other embodiments, the material may have a refractive index that is higher than a refractive index of the light guide material. Such a higher index material layer may be used to improve brightness of the emitted light 102, for example.

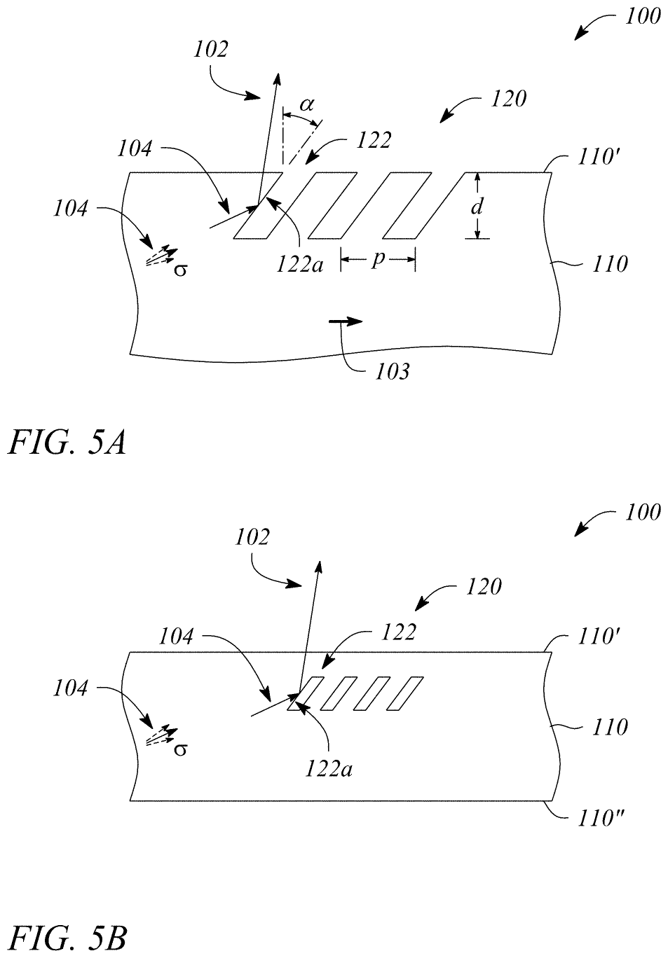

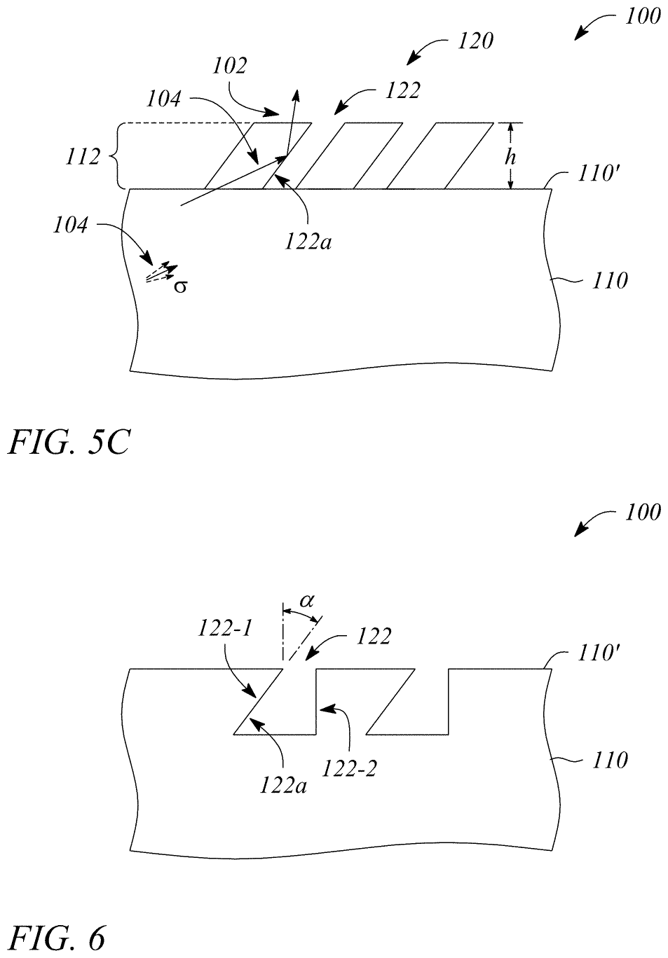

FIG. 5A illustrates a cross-sectional view of a portion of a multiview backlight 100 in an example, according to an embodiment of the principles described herein. As illustrated in FIG. 5A, the multiview backlight 100 comprises the light guide 110 with a micro-slit multibeam element 120 disposed on the first surface 110′ of the light guide 110. The micro-slit multibeam element 120 illustrated in FIG. 5A comprises the micro-slit sub-element plurality having micro-slit sub-elements 122 that extend into an interior of the light guide 110. As illustrated, guided light 104 is reflected by the sloped reflective sidewall 122a of the micro-slit sub-element 122 and exits the emission surface of the light guide 110 (e.g., the first surface 110′) as the emitted light 102. Further, as illustrated in FIG. 5A, the sloped reflective sidewall 122a of the micro-slit sub-element 122 has a slope angle α that is tilted away from the propagation direction 103 of the guided light 104. In some embodiments, a depth d of the micro-slit sub-element(s) 122 may be about equal to a pitch p of (or spacing) between adjacent micro-slit sub-elements 122 within the micro-slit multibeam element 120.

FIG. 5B illustrates a cross-sectional view of a portion of a multiview backlight 100 in an example, according to another embodiment of the principles described herein. As illustrated in FIG. 5B, the multiview backlight 100 comprises the light guide 110 and a micro-slit multibeam element 120. However, in FIG. 5B the micro-slit multibeam element 120 is located within the light guide 110 between the first and second surfaces 110′, 110″. As in FIG. 5A, guided light 104 is illustrated in FIG. 5B as being reflected by the sloped reflective sidewall 122a of the micro-slit sub-element 122 and exiting the emission surface of the light guide 110 (first surface 110′) as the emitted light 102.

FIG. 5C illustrates a cross-sectional view of a portion of a multiview backlight 100 in an example, according to another embodiment of the principles described herein. As illustrated, the multiview backlight 100 also comprises the light guide 110 having an optical material layer 112 disposed on the first surface 110′ of the light guide 110. The micro-slit multibeam element 120 illustrated in FIG. 5C is located in the optical material layer 112 and the micro-slit sub-elements 122 of the micro-slit sub-element plurality extend away from an emission surface comprising a surface of the optical material layer 112 and toward the first surface 110′ of the light guide 110. Further, a depth of the micro-slit sub-elements 122 may be comparable to a thickness or height h of the optical material layer 112, e.g., as illustrated. In FIG. 5C, guided light 104 is illustrated passing from the light guide 110 into the optical material layer 112 and then subsequently being reflected by the sloped reflective sidewall 122a of the micro-slit sub-element 122 to provide the emitted light 102.

Note that while each of the micro-slit sub-elements 122 of the micro-slit multibeam element 120 illustrated in FIGS. 5A-5C as being similar in size and shape, in some embodiments (not illustrated) micro-slit sub-elements 122 of the micro-slit sub-element plurality may differ from one another. For example, the micro-slit sub-elements 122 may have one or more of different sizes, different cross-sectional profiles, and even different orientations (e.g., a rotation relative to the guided light propagation directions) within and across the micro-slit multibeam element 120. In particular, at least two micro-slit sub-elements 122 of the micro-slit sub-element plurality may have different reflective scattering profiles from one another within the emitted light 102, according to some embodiments.

According to some embodiments, the sloped reflective sidewall 122a of the micro-slit sub-element 122 of the micro-slit sub-element plurality is configured to reflectively scatter out a portion of the guided light 104 according to total internal reflection (i.e., due to a difference between a refractive index of materials on either side of the sloped reflective sidewall 122a). That is, the guided light 104 having an incident angle of less than a critical angle at the sloped reflective sidewall 122a is reflected by the sloped reflective sidewall 122a to become the emitted light 102.

In some embodiments, the slope angle α of the sloped reflective sidewall 122a is between zero degrees (0°) and about forty-five degrees (45°) relative to a surface normal of the emission surface of the light guide 110 (or equivalently of the multiview backlight 100). In some embodiments, the slope angle α of the sloped reflective sidewall 122a is between 10 degrees (10°) and about forty degrees (40°). For example, the slope angle α of the sloped reflective sidewall 122a may be about twenty degrees (20°), or about thirty degrees (30°), or about thirty-five degrees (35°), relative to a surface normal of the emission surface of the light guide 110.

According to various embodiments, the slope angle α is selected in conjunction with the non-zero propagation angle of the guided light 104 to provide a target angle of the emitted light 102 comprising the directional light beams. Further, the selected slope angle α may be configured to preferentially scatter light in a direction of the emission surface of the light guide 110 (e.g., the first surface 110′) and away from a surface of the light guide 110 opposite to the emission surface (e.g., the second surface 110″). That is, the sloped reflective sidewall 122a may provide little or substantially no scattering of the guided light 104 in a direction away from the emission surface, in some embodiments.

In some embodiments, the sloped reflective sidewall 122a of a micro-slit sub-element 122 of the micro-slit sub-element plurality comprises a reflective material configured to reflectively scatter out a portion of the guided light 104. For example, the reflective material may be a layer of a reflective metal (e.g., aluminum, nickel, gold, silver, chrome, copper, etc.) or a reflective metal-polymer (e.g., polymer-aluminum) that coated on the sloped reflective sidewall 122a. In another example, an interior of the micro-slit sub-element 122 may be filled or substantially filled with the reflective material. The reflective material that fills the micro-slit sub-element 122 may provide reflective scattering of the guided light portion at the sloped reflective sidewall 122a, in some embodiments.

In some embodiments (e.g., as illustrated in FIGS. 5A-5C), a first sidewall of a micro-slit sub-element of the micro-slit sub-element plurality has a slope angle that is substantially similar to a slope angle of a second sidewall of the micro-slit sub-element. That is opposing sidewalls of the micro-slit sub-element may be substantially parallel to one another. In other embodiments, the first sidewall of a micro-slit sub-element of micro-slit sub-element plurality may have a slope angle that differs from slope angle of a second sidewall of the micro-slit sub-element, the first sidewall being the sloped reflective sidewall 122a.

FIG. 6 illustrates a cross-sectional view of a portion of a multiview backlight 100 including a micro-slit sub-element 122 in an example, according to an embodiment consistent with the principles described herein. As illustrated, the micro-slit sub-element 122 is depicted at a first surface 110′ of the light guide 110 with the first sidewall 122-1 of the micro-slit sub-element 122 representing the sloped reflective sidewall 122a having a slope angle α. Further, a second sidewall 122-2 of the micro-slit sub-element 122 has a different slope angle from the slope angle α of the first sidewall 122-1, as illustrated. In particular, the second sidewall 122-2 illustrated in FIG. 6 has a slope angle of about zero degrees (0°), i.e., the slope angle of the second sidewall 122-2 is substantially parallel to a surface normal of the first surface 110′ of the light guide 110, as illustrated.

In some embodiments, a micro-slit sub-element of the micro-slit sub-element plurality may have a curved shape in a direction that is orthogonal to the guided light propagation direction 103. In particular, the curved shape may be in a direction that is orthogonal to the propagation direction 103 and also in a plane parallel to a surface of the light guide 110. According to some embodiments, the curved shape may be configured to control emission pattern of scattered light in a plane orthogonal to the guided light propagation direction.

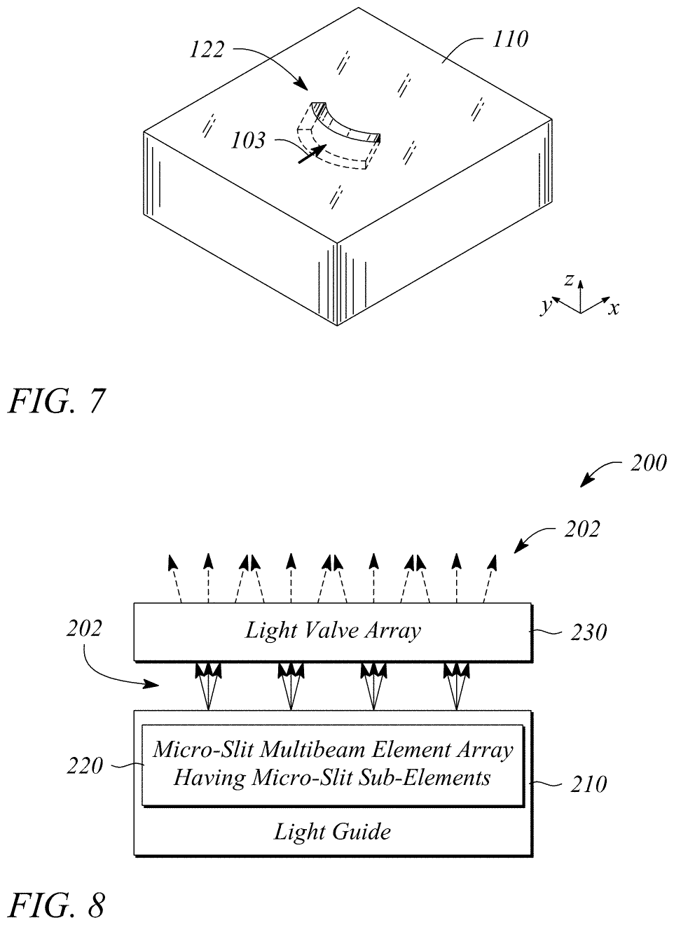

FIG. 7 illustrates a perspective view of a curved micro-slit sub-element 122 in an example, according to an embodiment consistent with the principles described herein. As illustrated, the curved micro-slit sub-element 122 is located in the light guide 110 and has a curved shape that is convex relative to the propagation direction 103 of the guided light. The convex curved shape of the micro-slit sub-element 122 may be used to increase a spread the reflectively scattered light in x-y direction, as illustrated. In another example (not illustrated), the curved shape of the micro-slit sub-element 122 may be concave relative to the propagation direction 103 to decrease a spread of the reflectively scattered light, for example. Further, a radius of curvature of the curved shape may be preferentially selected to control an amount of spread of the reflectively scattered light, in some embodiments. FIGS. 4A-4B also illustrate curved micro-slit sub-elements 122.

In accordance with some embodiments of the principles described herein, a multiview display is provided. The multiview display is configured to emit modulated light beams as view pixels of the multiview display to provide a multiview image. The emitted, modulated light beams have different principal angular directions from one another. Further, the emitted, modulated light beams may be preferentially directed toward a plurality of viewing directions or views of the multiview display or equivalent of the multiview image. In non-limiting examples, the multiview image may include one-by-four (1×4), one-by-eight (1×8), two-by-two (2×2), four-by-eight (4×8) or eight-by-eight (8×8) views with a corresponding number of view directions. The multiview display including a plurality of views in a one direction but not in another (e.g., 1×4 and 1×8 views) may be referred to as a ‘horizontal parallax only’ multiview display in that these configurations may provide views representing different view or scene parallax in one direction (e.g., a horizontal direction as horizontal parallax), but not in an orthogonal direction (e.g., a vertical direction with no parallax). The multiview display that includes more than one scene in two orthogonal directions may be referred to a full-parallax multiview display in that view or scene parallax may vary on both orthogonal directions (e.g., both horizontal parallax and vertical parallax). In some embodiments, the multiview display is configured to provide a multiview display having three-dimensional (3D) content or information. The different views of the multiview display or multiview image may provide a ‘glasses free’ (e.g., autostereoscopic) representation of information in the multiview image being displayed by the multiview display, for example.

FIG. 8 illustrates a block diagram of a multiview display 200 in an example, according to an embodiment consistent with the principles described herein. According to various embodiments, the multiview display 200 is configured to display a multiview image according to different views in different view directions. In particular, modulated directional light beams of the emitted light 202 emitted by the multiview display 200 may be used to display the multiview image and may correspond to pixels of the different views (i.e., view pixels). In FIG. 8, arrows having dashed lines are used to represent modulated directional light beams of the emitted light 202 to emphasize the modulation thereof, by way of example and not limitation.

As illustrated in FIG. 8, the multiview display 200 comprises a light guide 210. The light guide 210 is configured to guide light in a propagation direction as guided light. The light may be guided, e.g., as a guided light beam, according to total internal reflection, in various embodiments. For example, the light guide 210 may be a plate light guide configured to guide light from a light-input edge thereof as a guided light beam. In some embodiments, the light guide 210 of the multiview display 200 may be substantially similar to the light guide 110 described above with respect to the multiview backlight 100.

The multiview display 200 illustrated in FIG. 8 further comprises an array of micro-slit multibeam elements 220. According to various embodiments, micro-slit multibeam elements 220 of the micro-slit multibeam element array are spaced apart from one another across the light guide 110. Micro-slit multibeam elements 220 of the micro-slit multibeam element array comprise a plurality of micro-slit sub-elements. In addition, the micro-slit multibeam elements 220 are configured to reflectively scatter out the guided light as emitted light 202 comprising directional light beams having directions corresponding to respective view directions of a multiview image displayed by the multiview display 200. The directional light beams of the emitted light 202 have different principal angular directions from one another. The different principal angular directions of the directional light beams correspond to different view directions of respective ones of the different views of the multiview image, according to various embodiments. In some embodiments, the micro-slit multibeam elements 220 including the micro-slit sub-elements of the multiview display 200 may be substantially similar to the micro-slit multibeam elements 120 and micro-slit sub-elements 122, respectively, of the above-described multiview backlight 100. In particular, each micro-slit sub-element of the micro-slit sub-element plurality comprises a sloped reflective sidewall having a slope angle tilted away from the propagation direction of the guided light.

As illustrated in FIG. 8, the multiview display 200 further comprises an array of light valves 230. The array of light valves 230 is configured to modulate the directional light beams of the emitted light 202 to provide the multiview image. In some embodiments, the array of light valves 230 may be substantially similar to the array of light valves 108, described above with respect to the multiview backlight 100. In some embodiments, a size of the micro-slit multibeam elements is between about twenty-five percent (25%) and about two hundred percent (200%) a size of a light valve 230 of the light valve array. In other embodiments, other relative sizes of the micro-slit multibeam elements 220 and light valves 230 may be employed, as described above with respect to the micro-slit multibeam elements 120 and light valves 108.

In some embodiments, the guided light may be collimated according to a predetermined collimation factor. In some embodiments, an emission pattern of the emitted light is a function of the predetermined collimation factor of the guided light. For example, predetermined collimation factor may be substantially similar to the predetermined collimation factor σ, described above with respect to the multiview backlight 100.

In some embodiments, a micro-slit sub-element of the micro-slit sub-element plurality of the micro-slit multibeam elements 220 may be disposed on a surface of the light guide 210. For example, the surface may be either an emission surface of the light guide 210 or a surface of the light guide that is opposite to the emission surface of the light guide 210, e.g., as is described above with respect to the multiview backlight 100. In these embodiments, the micro-slit sub-element may extend into an interior of the light guide. In other embodiments, the micro-slit sub-element may be disposed within the light guide 210, between and spaced apart from the light guide surfaces.

In some embodiments, a micro-slit sub-element of the micro-slit sub-element plurality is configured to reflectively scatter out a portion of the guided light according to total internal reflection. In some embodiments, a micro-slit sub-element of the micro-slit sub-element plurality further comprises a reflective material (such as, but not limited to, a reflective metal or a metal-polymer) adjacent to and coating the sloped reflective sidewall of the micro-slit sub-element, described above.

In some embodiments, a slope angle of the sloped reflective sidewall of a micro-slit sub-element of the micro-slit sub-element is between zero degrees (0°) and about forty-five degrees (45°) relative to a surface normal of an emission surface of the light guide 210. In some embodiments, a micro-slit sub-element of the micro-slit sub-element plurality has a curved shape in a direction that is both orthogonal to the guided light propagation direction and parallel to a surface of the light guide. The curved shape may be configured to control emission pattern of scattered light in a plane orthogonal to the guided light propagation direction, for example.

In some embodiments, light valves 230 of the light valve array are arranged in sets representing multiview pixels of the multiview display 200. In some embodiments, the light valves represent sub-pixels of the multiview pixels. In some embodiments, micro-slit multibeam elements 220 of the micro-slit multibeam element array have a one-to-one correspondence to the multiview pixels of the multiview display 200.

In some of these embodiments (not illustrated in FIG. 8), the multiview display 200 may further comprise a light source. The light source may be configured to provide the light to the light guide 210 with a non-zero propagation angle and, in some embodiments, is collimated according to a predetermined collimation factor to provide a predetermined angular spread of the guided light within the light guide 210. According to some embodiments, the light source may be substantially similar to the light source 130, described above with respect to the multiview backlight 100.

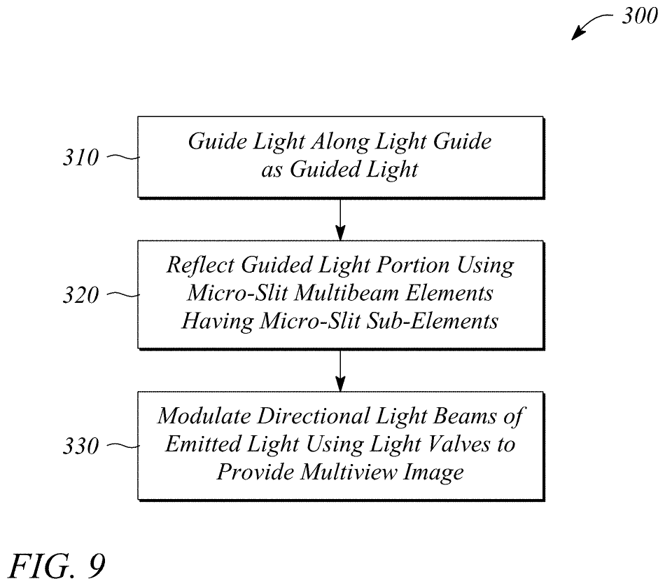

In accordance with some embodiments of the principles described herein, a method of multiview backlight operation is provided. FIG. 9 illustrates a flow chart of a method 300 of multiview backlight operation in an example, according to an embodiment consistent with the principles described herein. As illustrated in FIG. 9, the method 300 of multiview backlight operation comprises guiding 310 light in a propagation direction along a length of a light guide as guided light. In some embodiments, the light may be guided 310 at a non-zero propagation angle. Further, the guided light may be collimated. In particular, the guided light may be collimated according to a predetermined collimation factor. According to some embodiments, the light guide may be substantially similar to the light guide 110 described above with respect to the multiview backlight 100. In particular, the light may be guided according to total internal reflection within the light guide, according to various embodiments. Similarly, the predetermined collimation factor and non-zero propagation angle may be substantially similar to the predetermined collimation factor σ and non-zero propagation angle described above with respect to the light guide 110 of the multiview backlight 100.

As illustrated in FIG. 9, the method 300 of multiview backlight operation further comprises reflecting 320 a portion of the guided light out of the light guide using an array of micro-slit multibeam elements to provide emitted light comprising directional light beams having different directions corresponding to respective different view directions of a multiview display. In various embodiments, the different directions of the directional light beams correspond to respective view directions of a multiview display. In various embodiments, a micro-slit multibeam element of the micro-slit multibeam element array comprises a plurality of micro-slit sub-elements. Further, each micro-slit sub-element of the micro-slit sub-element plurality comprises a sloped reflective sidewall having a slope angle tilted away from the propagation direction of the guided light, by definition herein. In some embodiments, a size of each micro-slit multibeam element is between twenty-five percent and two hundred percent of a size of a light valve in an array of light valves of the multiview display.

In some embodiments, the micro-slit multibeam element is substantially similar to the micro-slit multibeam element 120 of the multiview backlight 100, described above. In particular, the plurality of micro-slit sub-elements of the micro-slit multibeam element may be substantially similar to the plurality of micro-slit sub-elements 122, described above.

In some embodiments, a micro-slit sub-element of the micro-slit sub-element plurality is disposed on a surface of the light guide, e.g., either an emission surface or a surface opposite the emission surface of the light guide. In other embodiments, the micro-slit sub-element of the micro-slit sub-element plurality is located between and spaced apart from opposing light guide surfaces. According to various embodiments, an emission pattern of the emitted light may be a function, at least in part, of the predetermined collimation factor of the guided light.

In some embodiments, the sloped reflective sidewall reflectively scatters light out of the light guide according to total internal reflection to provide the emitted light. In other embodiments, a micro-slit multibeam element of the micro-slit multibeam element array further comprises a reflective material adjacent to and coating the sloped reflective sidewall of the plurality of micro-slit sub-elements.

In some embodiments, the slope angle the sloped reflective sidewall is between zero degrees (0°) and about forty-five degrees (45°) relative to a surface normal of an emission surface of the light guide. According to various embodiments, the slope angle is chosen in conjunction with the non-zero propagation angle of the guided light to preferentially scatter light in a direction of the emission surface of the light guide and away from a surface of the light guide opposite to the emission surface.

In some embodiments (not illustrated), the method of multiview backlight operation further comprises providing light to the light guide using a light source. The provided light one or both of may have a non-zero propagation angle within the light guide and may be collimated within the light guide according to a collimation factor to provide a predetermined angular spread of the guided light within the light guide. In some embodiments, the light source may be substantially similar to the light source 130 of the multiview backlight 100, described above.

In some embodiments (e.g., as illustrated in FIG. 9), the method 300 of multiview backlight operation further comprises modulating 330 directional light beams of the emitted light reflectively scattered out by the micro-slit multibeam elements using light valves to provide a multiview image. According to some embodiments, a light valve of a plurality or an array of light valves corresponds to a sub-pixel of a multiview pixel and sets of light valves of the light valve array correspond to or are arranged as multiview pixels of a multiview display. That is, the light valve may have a size comparable to a size of the sub-pixel or a size comparable to a center-to-center spacing between the sub-pixels of the multiview pixel, for example. According to some embodiments, the plurality of light valves may be substantially similar to the array of light valves 108 described above of the multiview backlight 100, as described above. In particular, different sets of light valves may correspond to different multiview pixels in a manner similar to the correspondence of the first and second light valve sets 108a, 108b to different multiview pixels 106. Further, individual light valves of the light valve array may correspond to sub-pixels of the multiview pixels as the above-described light valve 108 corresponds to the sub-pixel in the above-reference discussion.

Thus, there have been described examples and embodiments of a multiview backlight, a method of multiview backlight operation, and a multiview display that employ micro-slit multibeam elements comprising micro-slit sub-elements having a sloped reflective sidewall to provide emitted light including directional light beams having directions corresponding to different directional views of a multiview image. It should be understood that the above-described examples are merely illustrative of some of the many specific examples that represent the principles described herein. Clearly, those skilled in the art can readily devise numerous other arrangements without departing from the scope as defined by the following claims.

What is claimed is:

1. A multiview backlight comprising:
a light guide configured to guide light in a propagation direction as guided light having a non-zero propagation angle and a predetermined collimation factor; and
an array of micro-slit multibeam elements spaced apart from one another across the light guide, each micro-slit multibeam element of the micro-slit multibeam element array comprising a plurality of micro-slit sub-elements and being configured to reflectively scatter out a portion of the guided light as emitted light comprising directional light beams having directions corresponding to respective view directions of a multiview display,
wherein each micro-slit sub-element of the micro-slit sub-element plurality comprises a sloped reflective sidewall having a slope angle tilted away from the propagation direction of the guided light.

2. The multiview backlight of claim 1, wherein a size of each micro-slit multibeam element is between twenty-five percent and two hundred percent of a size of a light valve in an array of light valves of the multiview display.

3. The multiview backlight of claim 1, wherein the micro-slit multibeam element is disposed on a emission surface of the light guide, a micro-slit sub-element of the micro-slit sub-element plurality extending into an interior of the light guide away from the emission surface.

4. The multiview backlight of claim 1, wherein the micro-slit multibeam element is disposed in a light guide material layer located on a surface of the light guide, a surface of the light guide material layer being an emission surface, and a micro-slit sub-element of the micro-slit sub-element plurality extending away from the emission surface and toward the light guide surface.

5. The multiview backlight of claim 4, wherein refractive index of the light guide material layer located on the surface of the light guide is greater than a refractive index of a material of the light guide.

6. The multiview backlight of claim 1, wherein the sloped reflective sidewall of a micro-slit sub-element of the micro-slit sub-element plurality is configured to reflectively scatter out a portion of the guided light according to total internal reflection.

7. The multiview backlight of claim 1, wherein the sloped reflective sidewall of a micro-slit sub-element of the micro-slit sub-element plurality comprises a reflective material configured to reflectively scatter out a portion of the guided light.

8. The multiview backlight of claim 1, wherein the slope angle of the sloped reflective sidewall is between zero degrees and about forty-five degrees relative to a surface normal of an emission surface of the light guide, the slope angle being configured to preferentially scatter light in a direction of the emission surface of the light guide and away from a surface of the light guide opposite to the emission surface.

9. The multiview backlight of claim 1, wherein a micro-slit sub-element of the micro-slit sub-element plurality has a curved shape in a direction that is both orthogonal to the guided light propagation direction and parallel to a plane of a surface of the light guide, the curved shape being configured to control emission pattern of scattered light in a plane orthogonal to the guided light propagation direction.

10. The multiview backlight of claim 1, wherein one or both of a depth of the micro-slit sub-elements of the micro-slit sub-element plurality is about equal to a spacing between adjacent micro-slit sub-elements within the micro-slit sub-element plurality, and a first sidewall of a micro-slit sub-element of micro-slit sub-element plurality has a slope angle that differs from slope angle of a second sidewall of the micro-slit sub-element, the first sidewall being the sloped reflective sidewall.

11. A multiview display comprising the multiview backlight of claim 1, the multiview display further comprising an array of light valves configured to modulate the directional light beams to provide a multiview image having directional views corresponding to the view directions of the multiview display.

12. A multiview display comprising:
a light guide configured to guide light in a propagation direction as guided light;
an array of micro-slit multibeam elements spaced apart from one another across the light guide, micro-slit multibeam elements of the micro-slit multibeam element array each comprising a plurality of micro-slit sub-elements and being configured to reflectively scatter out the guided light as emitted light comprising directional light beams having directions corresponding to respective view directions of a multiview image; and
an array of light valves configured to modulate the directional light beams to provide the multiview image,
wherein each micro-slit sub-element of the micro-slit sub-element plurality comprises a sloped reflective sidewall having a slope angle tilted away from the propagation direction of the guided light.

13. The multiview display of claim 12, wherein a size of the micro-slit multibeam elements is between twenty-five percent and two hundred percent of a size of a light valve of the light valve array.

14. The multiview display of claim 12, wherein the guided light is collimated according to a predetermined collimation factor, an emission pattern of the emitted light being a function of the predetermined collimation factor of the guided light.

15. The multiview display of claim 12, wherein a micro-slit sub-element of the micro-slit sub-element plurality is disposed on an emission surface of the light guide, the micro-slit sub-element extending into an interior of the light guide.

16. The multiview display of claim 12, wherein the sloped reflective sidewall of a micro-slit sub-element of the micro-slit sub-element plurality is configured to reflectively scatter out a portion of the guided light according to total internal reflection.

17. The multiview display of claim 12, wherein one or both of the slope angle of sloped reflective sidewall is between zero degrees and about forty-five degrees relative to a surface normal of an emission surface of the light guide, and a micro-slit sub-element of the micro-slit sub-element plurality has a curved shape in a direction that is both orthogonal to the guided light propagation direction and parallel to a surface of the light guide, the curved shape being configured to control emission pattern of scattered light in a plane orthogonal to the guided light propagation direction.

18. The multiview display of claim 12, wherein light valves of the light valve array are arranged in sets representing multiview pixels of the multiview display, the light valves representing sub-pixels of the multiview pixels, and wherein micro-slit multibeam elements of the micro-slit multibeam element array have a one-to-one correspondence to the multiview pixels of the multiview display.

19. A method of multiview backlight operation, the method comprising:
guiding light in a propagation direction along a length of a light guide as guided light having a non-zero propagation angle and a predetermined collimation factor; and
reflecting a portion of the guided light out of the light guide using an array of micro-slit multibeam elements to provide emitted light comprising directional light beams having different directions corresponding to respective different view directions of a multiview display, a micro-slit multibeam element of the micro-slit multibeam element array comprising a plurality of micro-slit sub-elements,
wherein each micro-slit sub-element of the micro-slit sub-element plurality comprises a sloped reflective sidewall having a slope angle tilted away from the propagation direction of the guided light.

20. The method of multiview backlight operation of claim 19, wherein the sloped reflective sidewall reflectively scatters light according to total internal reflection to reflect the portion of the guided light out of the light guide to provide the emitted light.

21. The method of multiview backlight operation of claim 19, wherein the slope angle of the sloped reflective sidewall is between zero degrees and about forty-five degrees relative to a surface normal of an emission surface of the light guide, the slope angle being chosen in conjunction with the non-zero propagation angle of the guided light to preferentially scatter light in a direction of the emission surface of the light guide and away from a surface of the light guide opposite to the emission surface.

22. The method of multiview backlight operation of claim 19, the method further comprising:
modulating the directional light beams using an array of light valves to provide a multiview image,
wherein a size of the micro-slit multibeam elements is between twenty-five percent and two hundred percent of a size of a light valve of the light valve array.
